(19) United States
(12) Patent Application Publication
(10) Pub. No.: US 2011/0254870 A1
(43) Pub. Date: Oct. 20, 2011

(54) CONTRAST ENHANCEMENT SYSTEM AND METHOD FOR PROJECTOR

(75) Inventor: PANG-CHENG WANG, Tu-Cheng (TW)

(73) Assignee: HON HAI PRECISION INDUSTRY CO., LTD., Tu-Cheng (TW)

(21) Appl. No.: 12/915,049

(22) Filed: Oct. 29, 2010

(30) Foreign Application Priority Data
Apr. 14, 2010 (TW) 99111526

(51) Int. Cl. G09G 5/10

(52) U.S. Cl. 345/690

(57) ABSTRACT

A contrast enhancement system for a projector includes a detection module detecting a gray level of a standby projection image, a determination module comparing the gray level to a predetermined gray level, a control module directing the projector to work in an economic mode when the gray level is higher than the predetermined gray level, or directing the projector to work in a standard mode conversely, a modulation module increasing a gain of the non-white waveform of light from the projector to make the projector project a full dark image when the projector is working in the economic mode, a calculation module calculating a first contrast value of the full light image, a second contrast value of the full dark image, and a total contrast according to the first and second contrast values, and an execution module controlling the projector to project projection images according to the total contrast.

### BACKGROUND

1. Technical Field

The present disclosure relates to projectors, and more particularly, to a contrast enhancement system and method for a projector.

2. Description of Related Art

TI's DynamicBlack technology is used to improve the total contrast of scenes in projection products. However, DynamicBlack technology itself can improve only about 14% for contrast. Also for the same purpose in improvement of the contrast, Osram company and Philips company have developed two similar technologies named UNISHAPE (Universal Shaped Light Waveform) and Vivid. Using either, light intensity is adapted to the image content with millisecond precision, similar to a waveform generator. The adapted light waveform shape is repeated in synchronization with a DMD and a color wheel employed in the projector, and results in an improvement in contrast of about 15%.

However, in some special and professional conditions, such an improvement does not satisfy specific requirements.

What is needed, therefore, is contrast enhancement system and method for a projector which can overcome or at least alleviate the described limitations.

### BRIEF DESCRIPTION OF THE DRAWINGS

FIG. 1 is a schematic view of a projector according to an exemplary embodiment.

FIG. 2 is a block diagram of functional modules of a contrast enhancement system for the projector of FIG. 1.

FIG. 3 illustrates a waveform of light from a light source of the projector of FIG. 1, wherein the horizontal axis and the vertical axis represent color distribution and gain value, respectively.

FIG. 4 is a schematic diagram of a full light/dark image projected from the projector of FIG. 1.

FIG. 5 is a flowchart of a contrast enhancement method for the projector of FIG. 1.

### DETAILED DESCRIPTION

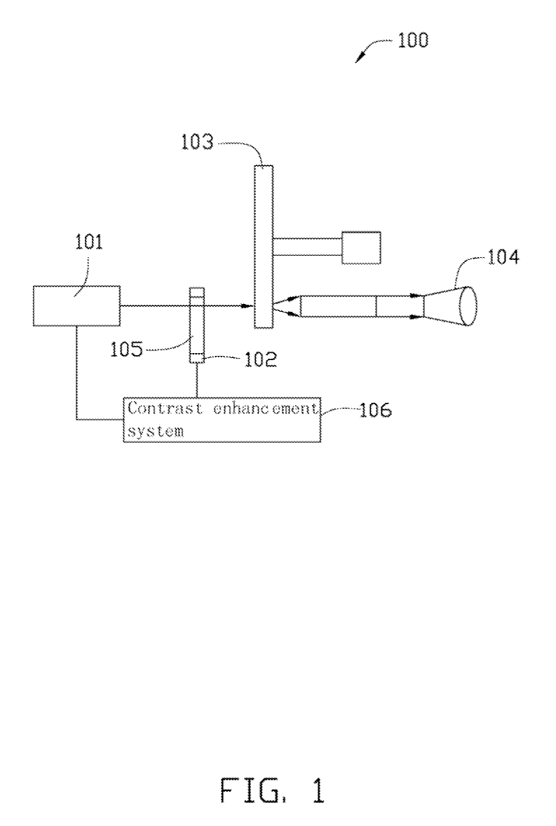

Referring to FIG. 1, a projector 100, according to an exemplary embodiment is shown. The projector 100 includes a light source 101, a light gate 102, a color wheel 103, and a projection lens 104. Light emitted from the light source 101 is transmitted to the light gate 102, the color wheel 103, and the projection lens 104 in sequence. The light gate 102 can determine light quantity entering the projection lens 104 by controlling an aperture 105 disposed thereof. In the present embodiment, the light source 101 emits composite white light. The projector 100 may be a liquid crystal display (LCD) projector, a digital light processing (DLP) projector, a liquid crystal on silicon (LCoS) projector, or other type. In the present embodiment, the projector 100 is a DLP projector presented as an example to explain configurations and working principles thereof.

The projector 100 further provides a standard mode and an economy mode. When the projector 100 is working on rated power, the standard mode is activated. The economic mode indicates the projector 100 is working on an energy saving mode.

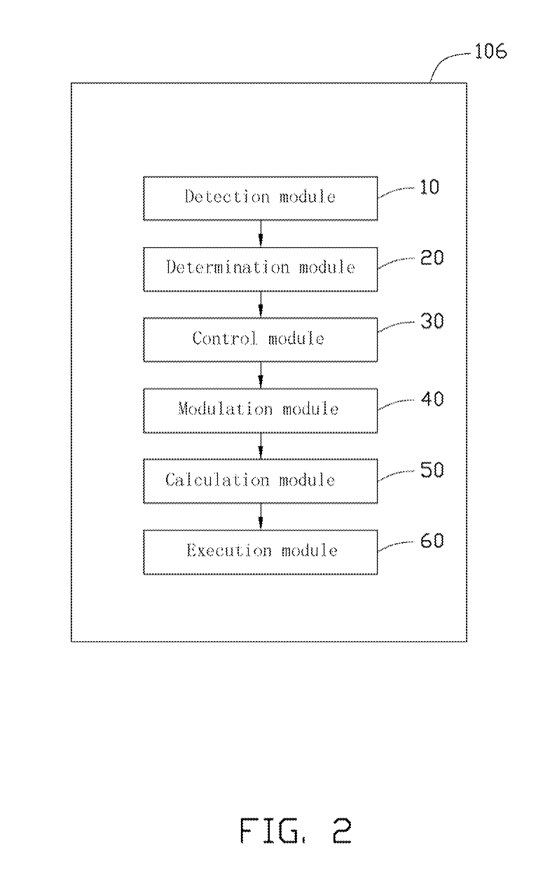

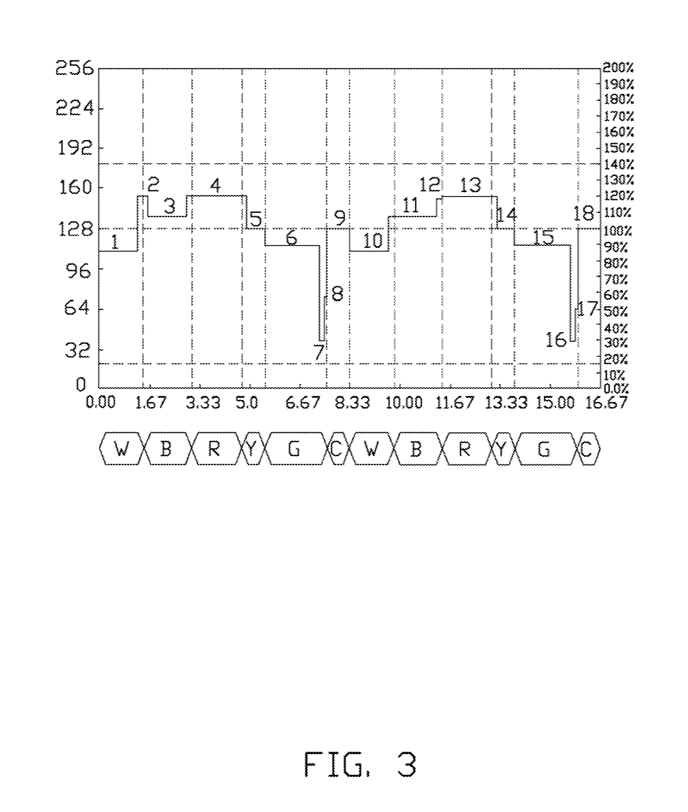

Also referring to FIGS. 2 and 3, a contrast enhancement system 106 for the projector 100 is schematically shown. Here, the contrast is equal to a division ratio of a brightness value of a full dark image (R, G, B=0,0,0) projected from the projector 100 divided by a brightness value of a full light image (R, G, B=255,255,255) also projected from the projector 100. The contrast enhancement system 106 can generate a total contrast to the projector 100, and the projector 100 can project images according to the total contrast from the contrast enhancement system 106. In the present embodiment, the contrast enhancement system 106 is embedded in the projector 100 and connected to the light source 101 and the light gate 102. In other embodiments, the contrast enhancement system 106 can be disposed as a peripheral device connected to the projector 100.

In detail, the contrast enhancement system 106 includes a detection module 10, a determination module 20, a control module 30, a modulation module 40, a calculation module 50, and an execution module 60. Note the modules 10-60 may comprise computerized code in the form of one or more programs that are stored in a memory (not shown) employed in the projector 100. The computerized code includes instructions that are executed by one or more CPUs to provide corresponding functions for the modules 10-60.

The detection module 10 detects a gray level of each projection image stored in the projector 100 ready to be projected, that is the projection image is finished processing by a CPU of the projector 100 or is processing by the CPU. The information of the projection image including the gray level is stored in the memory. The detection module 10 is connected to the memory for reading the gray level information from the memory. In the present embodiment, the detection module 10 is integrated in a processor (not shown) of the projector 100, the processor can control the detection module 10 to read the gray level from the memory. Note each projection image includes a number of dark sections and a number of bright sections. The gray level is the percentage of the dark sections in the whole projection image, that is, the greater the gray level is, the darker the projection image will be.

The determination module 20 compares the detected gray level to a predetermined gray level also stored in the memory, to determine whether the projector 100 functions in standard mode or in economic mode. In the present embodiment, the predetermined gray level is 40%. If the gray level achieved by the detection module 10 is lower than the predetermined gray level, the determination module 20 directs the projector 100 to work in the standard mode and outputs a first signal. If the gray level achieved by the detection module 10 is higher than the predetermined gray level, the determination module 20 directs the projector 100 to work in the economic mode and outputs a second signal.

The control module 30 directs the projector 100 to work in the economic mode and further controls the light gate 102 to narrow the aperture 105 for letting in less light thereof according to the second signal, and to decrease the power consumed by the light source 101. Furthermore, the control module 30 also controls the projector 100 to keep in working in the standard mode and controls the light gate 102 to let in more light according to the first signal, to project a full light image. In the present embodiment, the control module 30 leads into the DynamicBlack technology of TI corporation. Briefly, the DynamicBlack technology bases on controlling the size of the aperture 105 of light gate 102 to make the full light image lighter and the full dark image darker, to improve the total contrast of the projection image. In the present embodiment, when the projector 100 is switched from the standard mode to the economic mode, the output power is decreased from 180 W to 160 W.

The modulation module 40 modulates the frequency of light from the light source 101 when the projector 100 is controlled to work in the economic mode, to increase a gain of the non-white waveform of the light from the light source 101 to project a full dark image. While here, if the gain of the non-white waveform of the light from the light source 101 is increased, the gain of the white waveform of the light can be decreased at the same time. As such, the brightness of the full dark image is decreased. In the present embodiment, the modulation module 40 leads into the UNISHAPE (Universal Shaped Light Waveform) technology of Osram and the Vivid image processing technology of Philips. Briefly, the UNISHAPE and the Vivid technologies base on enhancing the non-white waveform of light to weak the white waveform of the same light thus decrease the brightness of the dark section of the image.

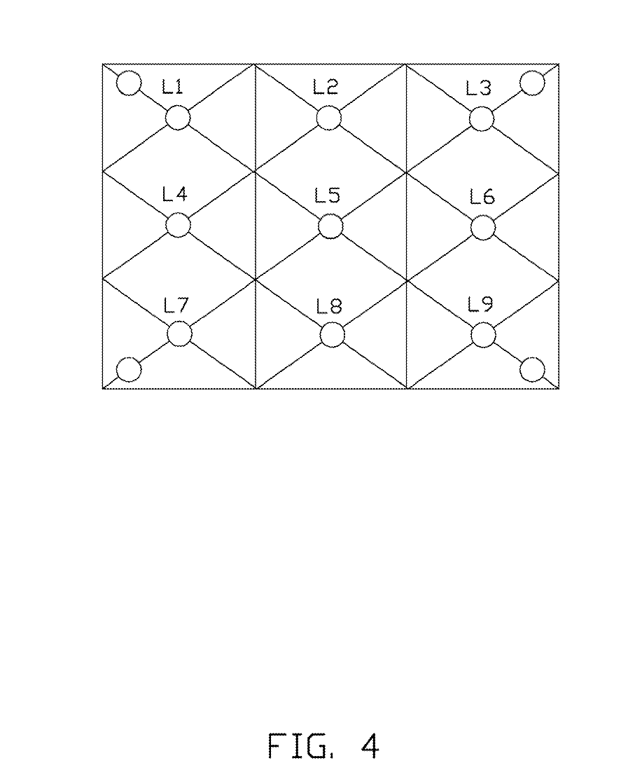

The calculation module 50 is configured for calculating a first contrast value of the full light image during the projector 100 working in the standard mode and a second contrast value of the full dark image during the projector 100 working in the economic mode, according to the brightness of the full light image and the full dark image, and then calculating the total contrast of the projection image according to the first contrast value and the second contrast value during in the economic mode. Referring to FIG. 4, in detail, the calculation module 50 measures the average brightness of nine test points L1˜L9 shown on the full light image to obtain the first contrast value, and then measures the average brightness of nine test points L′1˜L′9 shown on the full dark image to obtain the second contrast value. The calculation module 50 calculates the total contrast of the projection image according to the following formula: {(L1+L2+L3+L4+L5+L6+L7+L8+L9)/9}/{((L′1+L′2+L′3+L′4+L′5+L′6+L′7+L′8+L′9)/9 }. Wherein, the first contrast value equals to (L1+L2+L3+L4+L5+L6+L7+L8+L9)/9, and the second contrast value equals to (L′1+L′2+L′3+L′4+L′5+L′6+L′7+L′8+L′9)/9. Accordingly, since the total contrast equals to a division ratio of the first contrast value to the second contrast value, and the brightness of the full dark image is decreased, the total contrast can be improved.

The execution module 60 is connected to the calculation module 50 and configured for projecting the projection image according to the total contrast calculated by the calculation module 50 during in the economic mode. Since the total contrast is improved by cooperating the UNISHAPE/the Vivid with the DynamicBlack technology, by making the full light image lighter and the full dark image darker, the quality of the projection images are also highly improved.

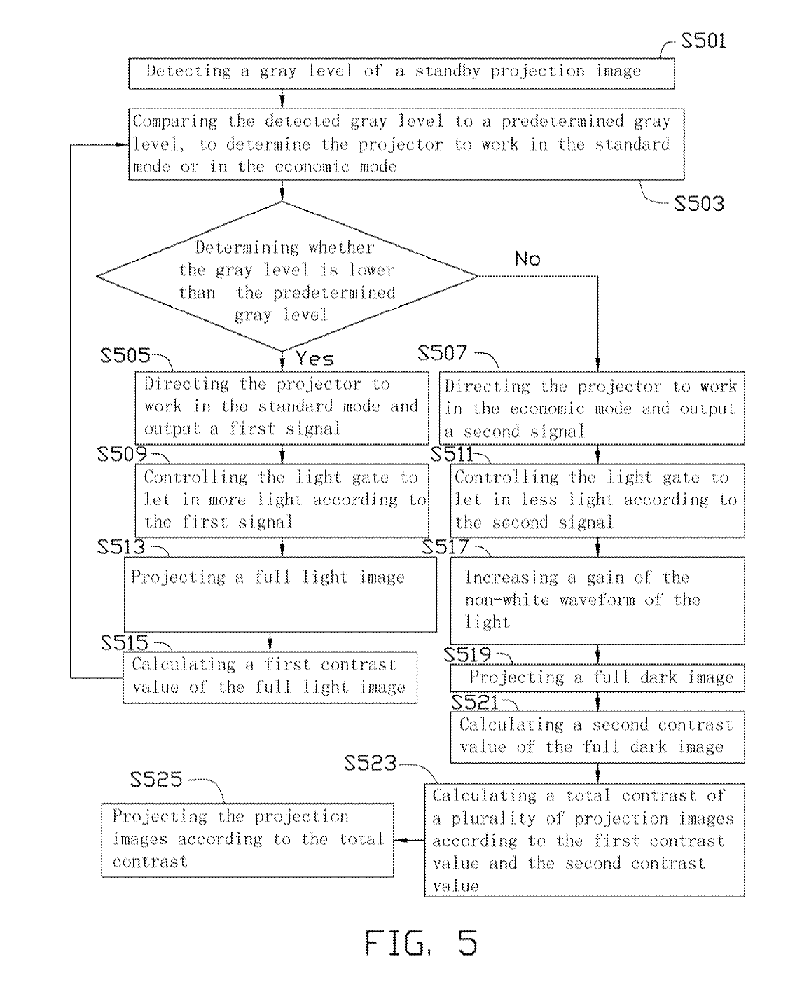

FIG. 5 is a flowchart of an exemplary embodiment of a contrast enhancement method used in the projector 100. The method includes the following steps.

In step S501, a gray level of a projection image ready to be projected, is detected.

In step S503, the detected gray level is compared to a predetermined gray level, to determine the projector 100 to work in the standard mode or in the economic mode.

When the gray level is lower than the predetermined gray level, the step S503 is transferred to step S505: the projector 100 is directed to work in the standard mode and output a first signal. Accordingly, when the gray level is higher than the predetermined gray level, the step S503 is transferred to step S507: the projector 100 is directed to work in the economic mode and output a second signal.

According to the first signal, the step S505 is transferred to step S509: the light gate 102 is further controlled to widen the aperture 105 to let in more light during the projector 100 working in standard mode. According to the second signal, the step S507 is transferred to step S511: the light gate 102 is controlled to narrow the aperture 105 thereof to let in less light during the projector 100 working in economic mode. In one embodiment, the DynamicBlack technology of TI corporation are used in steps S509 and S511.

In step S513, a full light image (R, G, B,=255,255,255) is projected when the projector 100 receives the first signal and the light gate 102 lets in more light, during the projector 100 working in standard mode.

In step S515, a first contrast value of the full light image is calculated by the projector 100 according to the brightness value of the full light image. In one embodiment, the first contrast value of the full light image is measured by the calculation module 50 (see FIG. 2). After the first contrast value of the full light image is calculated, step S515 is turned back to step S503, to compare the detected gray level to the predetermined gray level.

In step S517, the frequency of light from the light source 101 is modulated when the projector 100 is controlled to work in the economic mode and the light gate 102 is narrowed, to increase the gain of the non-white waveform of the light from the light source 101. While here, if the gain of the non-white waveform of light from the light source 101 is increased, the gain of the white waveform of light can be decreased at the same time. In the present embodiment, the UNISHAPE (Universal Shaped Light Waveform) technology of Osram and the Vivid image processing technology of Philips are used in this step.

In step S519, a full dark image (R, G, B,=0,0,0) is projected.

In step S521, a second contrast value of the full dark image is calculated according to the brightness of the full dark image. In one embodiment, the second contrast value of the full dark image is also calculated by the calculation module 50 (see FIG. 2).

In step S523, the total contrast of the projection image is calculated according to the first contrast value and the second contrast value. In one embodiment, the total contrast of the projection image is calculated by the calculation module 50 (see FIG. 2). The calculation module 50 calculates the total contrast of the projection image according to the following formula: {(L1+L2+L3+L4+L5+L6+L7+L8+L9)/9}/{((L′1+L′2+L′3+L′4+L′5+L′6+L′7+L′8+L′9)/9 }. Wherein, the first contrast value equals to (L1+L2+L3+L4+L5+L6+L7+L8+L9)/9, and the second contrast value equals to (L′1+L′2+L′3+L′4+L′5+L′6+L′7+L′8+L′9)/9. Accordingly, since the total contrast equals to a division ratio of the first contrast value to the second contrast value, and the second contrast value is dropped due to the decreasing brightness of the full dark image, the total contrast can be improved.

In step S525, the projection images are projected according to the total contrast.

While various exemplary embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A contrast enhancement system for a projector, the projector having a light source and providing a standard mode and an economic mode, the contrast enhancement system comprising:
a detection module configured for detecting a gray level of a standby projection image of the projector;
a determination module configured for comparing the detected gray level to a predetermined gray level, to determine whether the projector works in the standard mode or in the economic mode;
a control module configured for directing the projector to work in the economic mode when the gray level is higher than the predetermined gray level, or directing the projector to work in the standard mode and to project a full light image when the gray level is lower than the predetermined gray level;
a modulation module configured for increasing a gain of the non-white waveform of light from the light source by modulating the frequency of the light when the projector is working in the economic mode, to make the projector project a full dark image;
a calculation module configured for calculating a first contrast value of the full light image, a second contrast value of the full dark image, and a total contrast of a plurality of projection images, wherein the total contrast is equal to the ratio of the first contrast value to the second contrast value; and
an execution module configured for controlling the projector to project the projection images according to the calculated total contrast.

2. The contrast enhancement system of claim 1, wherein the determination module is configured for determining the projector to work in the standard mode and outputting a first signal to the control module when the detected gray level is lower than the predetermined gray level, or determining the projector to work in the economic mode and outputting a second signal to the control module when the detected gray level is higher than the predetermined gray level.

3. The contrast enhancement system of claim 1, wherein the projector further comprises a light gate with an aperture, the control module is also configured for controlling the light gate to narrow the aperture to let in less light when the gray level is higher than the predetermined gray level, or controlling the light gate to enlarge the aperture to let in more light when the gray level is lower than the predetermined gray level.

4. The contrast enhancement system of claim 1, wherein the calculation module calculates the average brightness of the full light image to obtain the first contrast value, and calculates the average brightness of the full dark image to obtain the second contrast value.

5. The contrast enhancement system of claim 4, wherein the calculation module calculates the total contrast of the projection images according to the following formula: {(L1+L2+L3+L4+L5+L6+L7+L8+L9)/9}/{(L′1+L′2+L′3+L′4+L′5+L′6+L′7+L′8+L′9)/9}, the first contrast value equals to (L1+L2+L3+L4+L5+L6+L7+L8+L9)/9, and the second contrast value equals to (L′1+L′2+L′3+L′4+L′5+L′6+L′7+L′8+L′9)/9, L1˜L9 are brightness values of predetermined nine points of the full light image, L′1˜L′9 are brightness values of predetermined nine points of the full dark image.

6. A contrast enhancement method for a projector, the projector comprising a light source and providing a standard mode and an economic mode, the contrast enhancement method comprising the following steps:
detecting a gray level of a standby projection image of the projector;
comparing the detected gray level to a predetermined gray level, to determine the projector to work in the standard mode or in the economic mode;
directing the projector to work in the standard mode and output a first signal when the gray level is lower than the predetermined gray level, or directing the projector to work in the economic mode and output a second signal when the gray level is higher than the predetermined gray level;
projecting a full light image according the first signal;
increasing the gain of the non-white waveform of light from the light source when the projector is working in the economic mode;
projecting a full dark image according the second signal;
calculating a first contrast value of the full light image and a second contrast value of the full dark image;
calculating a total contrast of a plurality of projection images according to the first contrast value and the second contrast value, wherein the total contrast equals to the ratio of the first contrast value to the second contrast value; and
projecting the projection images according to the total contrast.

7. The contrast enhancement method of claim 6, wherein the projector further comprises a light gate with an aperture in front of the light source, the method further comprises: controlling the light gate to narrow the aperture to let in less light according to the second signal, or controlling the light gate to large the aperture to let in more light according to the first signal.

8. The contrast enhancement method of claim 7, wherein the first contrast value equals to (L1+L2+L3+L4+L5+L6+L7+L8+L9)/9, and the second contrast value equals to (L′1+L′2+L′3+L′4+L′5+L′6+L′7+L′8+L′9)/9, the L1˜L9 are brightness values of predetermined nine points of the full light image, the L′1˜L′9 are brightness values of predetermined nine points of the full dark image.
